(19) United States
(12) Patent Application Publication
(10) Pub. No.: US 2009/0037615 A1
(43) Pub. Date: Feb. 5, 2009

(54) DATA TRANSFER DEVICE, REQUEST ISSUING UNIT, AND REQUEST ISSUE METHOD

(75) Inventor: Takeshi KODAIRA, Tomi-city (JP)

Correspondence Address: DITTHAVONG MORI & STEINER, P.C., 918 Prince St., Alexandria, VA, 22314, US

(73) Assignee: MIMAKI ENGINEERING CO., LTD., Tomi-city (JP)

(21) Appl. No.: 12/181,107

(22) Filed: Jul. 28, 2008

(30) Foreign Application Priority Data
Aug. 3, 2007 (JP) 2007-203056

(51) Int. Cl. G06F 13/28

(52) U.S. Cl. 710/25

(57) ABSTRACT

A request issuing unit for issuing a request signal for requesting data transfer by direct memory access. The request issuing unit including a data presence determination section configured to determine whether or not transfer data, as an object of the data transfer, is present, and a signal outputting section configured to output a request signal for data transfer of a predetermined amount of data to be transferred at one time when the data presence determination section determines that the transfer data is present. The request issuing unit further including a determination timing control section configured to wait for a predetermined waiting period of time, required for completing the data transfer of at least the amount of data to be transferred at one time, after the signal outputting section outputs the request signal, and then makes the data presence determination section determine again whether or not transfer data is present.

### CROSS-REFERENCE TO RELATED APPLICATION

The present application claims priority to Japanese Patent Application No. 2007-203056, filed on Aug. 3, 2007, the entire contents of which are herein incorporated by reference.

### BACKGROUND OF THE INVENTION

1. Field of the Invention

The present invention relates to a data transfer device, a request issuing unit, and a request issuing method.

2. Discussion of the Background

One type of data transfer method performs data transfer using a Direct Memory Access (DMA) method. As a direct memory access controller (DMAC) for controlling data transfers by DMA, there is known a control arrangement that controls data transfers in response to request signals from external devices (e.g., JP-A-9-207371 and JP-A-2002-163229).

In control arrangements using a DMAC for controlling data transfers in response to request signals from external devices, the DMAC outputs an acknowledgement signal in response to a request signal in order to provide acknowledgement before the data transfer. In such a control arrangement, at least both the request signal and the acknowledgement signal are required for controlling the data transfer. Therefore, at least a signal wire for the request signal and a signal wire for the acknowledgement signal are conventionally required in a data transfer channel, thus increasing the system cost. In particular, when, for example, a plurality of data transfer channels are required according to the system, every channel requires a signal wire for the request signal and a signal wire for the acknowledgement signal, thus greatly increasing the system cost. Therefore, there is a need for an improved method and arrangement capable of solving the aforementioned problems.

### SUMMARY OF THE INVENTION

The present invention advantageously provides an embodiment in which a data transfer device for performing data transfer by direct memory access includes a memory, a request issuing unit configured to issue a request signal for requesting the data transfer to the memory, and a direct memory access controller configured to control the data transfer. The request issuing unit includes a data presence determination section configured to determine whether or not transfer data, as an object of the data transfer, is present, a signal outputting section configured to output a request signal for data transfer of a predetermined amount of data to be transferred at one time when the data presence determination section determines that the transfer data is present, and a determination timing control section configured to wait for a predetermined waiting period of time, required for completing data transfer of at least the predetermined amount of data to be transferred at one time, after the signal outputting section outputs the request signal, and then makes the data presence determination section to determine again whether or not transfer data is present. When the signal outputting section outputs the request signal, the direct memory access controller controls the data transfer by direct memory access of the amount of data to be transferred at one time in response to the request signal.

The present invention also advantageously provides an embodiment in which a request issuing unit for issuing a request signal for requesting data transfer by direct memory access includes a data presence determination section configured to determine whether or not transfer data, as an object of the data transfer, is present, a signal outputting section configured to output a request signal for data transfer of a predetermined amount of data to be transferred at one time when the data presence determination section determines that the transfer data is present, and a determination timing control section configured to wait for a predetermined waiting period of time, required for completing the data transfer of at least the amount of data to be transferred at one time, after the signal outputting section outputs the request signal, and then makes the data presence determination section determine again whether or not transfer data is present.

The present invention further advantageously provides an embodiment in which a request issuing method for issuing a request signal for requesting data transfer by direct memory access includes determining whether or not transfer data, as an object of the data transfer, is present, outputting a request signal for data transfer of a predetermined amount of data to be transferred at one time when it is determined that the transfer data is present, and waiting for a predetermined waiting period of time, required for completing the data transfer of at least the amount of data to be transferred at one time, after the request signal is outputted. After waiting for the predetermined waiting period of time, the method is returned to determining again whether or not transfer data is present.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is an illustration showing a printing system, according to an exemplary embodiment of the present invention;

FIG. 2 is an illustration showing a request issuing unit, according to an exemplary embodiment of the present invention; and

FIG. 3 is a flow chart showing an operation process of a request issuing unit, according to an exemplary embodiment of the present invention.

### DETAILED DESCRIPTION OF EMBODIMENTS OF THE INVENTION

Embodiments of the present invention will be described hereinafter with reference to the accompanying drawings. In the following description, the constituent elements having substantially the same function and arrangement are denoted by the same reference numerals, and repetitive descriptions will be made only when necessary.

A first embodiment or arrangement of the invention advantageously provides a data transfer device for performing data transfer by direct memory access. The data transfer device includes a memory, a request issuing unit for issuing a request signal for requesting the data transfer to the memory, and a direct memory access controller for controlling the data transfer. The request issuing unit includes a data presence determination section which determines whether or not transfer data as object of the data transfer are present, a signal outputting section which outputs a request signal for data transfer of a predetermined amount of data to be transferred at one time when the data presence determination section determines that the transfer data are present, and a determination timing control section which waits for a predetermined waiting period of time, required for completing the data transfer of at least the amount of data to be transferred at one time, after the signal outputting section outputs the request signal, and then makes the data presence determination section to determine again whether or not transfer data are present When the signal outputting section outputs the request signal, the direct memory access controller controls data transfer by direct memory access of the amount of data to be transferred at one time in response to the request signal.

The data transfer device is, for example, a printer for conducting printing.

The request issuing unit may issue a request signal without receiving an acknowledgement signal indicating that the direct memory access controller receives the request signal. As for terminals for control signals, the request issuing unit has, for example, a terminal for request signals and no terminal for acknowledgement signals.

According to this arrangement, the data presence determination section in the request issuing unit determines whether or not transfer data to be transferred are present. When the transfer data are present, the signal outputting section outputs a request signal so as to issue a request for data transfer to the direct memory access controller. Normally, the direct memory access controller receives a next request before completion of the data transfer. To prevent overlapping receipt of request signals, the request issuing unit issues, for example, a request signal of minimal time. The request signal of minimal time means is a request signal corresponding to data transfer requiring minimal period of time for completing the data transfer of at least the amount of data to be transferred at one time. After outputting the request signal, the request issuing unit waits for a period of time required for completing the data transfer to be conducted at one time.

According to this arrangement, it is possible to suitably prevent overlapping receipt of request signals. Furthermore, by waiting for a period of time required for completing the data transfer to be conducted at one time after outputting the request signal of minimal time, it is possible to suitably couple the outputting of the request signal and the data transfer. This also ensures the data transfer.

Since the overlapping receipt of request signals can be prevented and the outputting of the request signal and the data transfer can be coupled, it is possible to suitably perform data transfer by direct memory access without using an acknowledgement signal. Furthermore, since an acknowledgement signal is not required, it is possible to reduce the number of control signals required to control data transfer by direct memory access to half. This can also suitably reduce the system cost of the system for performing data transfer by direct memory access. Furthermore, since the number of signal wires required for controlling data transfer is reduced, the data transfer channels can be suitably provided even when only a small space is allowed for wiring.

The direct memory access controller controls direct memory access between the transfer target device provided as a part of the system and the memory. The transfer target device is, for example, an input/output device or a peripheral device and is connected to the memory via a data transfer channel. In the system, for example, a plurality of transfer target devices connected to the memory via respective data transfer channels can be provided. In this case, a signal wire for request signals is provided for each of the data transfer channels.

The direct memory access controller may be a conventionally well known direct memory access controller, such as a built-in direct memory access controller of a CPU (MPU), which can support the external request method of controlling data transfer in response to a request signal from an external device. In addition, the request issuing unit may be fabricated by using a FPGA or the like.

A second embodiment or arrangement of the invention advantageously provides a direct memory access controller that is able to control various types of the data transfers of which amounts to be transferred at one time are different, and a request issuing unit that issues a request signal for requesting data transfer of which amount to be transferred at one time is minimal, among the various types of data transfers.

According to this arrangement, the request issuing unit can suitably output a request signal of minimal time. In this case, the request issuing unit waits for a period of time required for completing data transfer of data to be transferred at one time corresponding to the request signal of minimal time. Accordingly, this arrangement can securely prevent overlapping receipt of request signals by the direct memory access controller. Additionally, this arrangement can securely couple the outputting of the request signal and the data transfer, thereby ensuring the data transfer by direct memory access.

A third embodiment or arrangement of the invention advantageously provides a request issuing unit for issuing a request signal for requesting data transfer by direct memory access. The request issuing unit includes a data presence determination section which determines whether or not transfer data as object of the data transfer are present, a signal outputting section which outputs a request signal for data transfer of a predetermined amount of data to be transferred at one time when the data presence determination section determines that the transfer data are present, and a determination timing control section which waits for a predetermined waiting period of time, required for completing the data transfer of at least the amount of data to be transferred at one time, after the signal outputting section outputs the request signal, and then makes the data presence determination section to determine again whether or not transfer data are present.

According to this arrangement, the same effects of the first arrangement can be obtained.

A fourth embodiment or arrangement of the invention advantageously provides a request issuing method for issuing a request signal for requesting data transfer by direct memory access. The request issuing method includes a data presence determination step for determining whether or not transfer data as object of the data transfer are present, a signal outputting step for outputting a request signal for data transfer of a predetermined amount of data to be transferred at one time when it is determined that the transfer data are present in the data presence determination step, and a waiting step for waiting for a predetermined waiting period of time, required for completing the data transfer of at least the amount of data to be transferred at one time, after the request signal is outputted. After the waiting step, the process is returned to the data presence determination step to determine again whether or not transfer data are present.

According to this arrangement, the same effects of the first arrangement can be obtained.

According to the present invention, it is possible to suitably reduce system cost of a system for performing data transfer by direct access memory, for example.

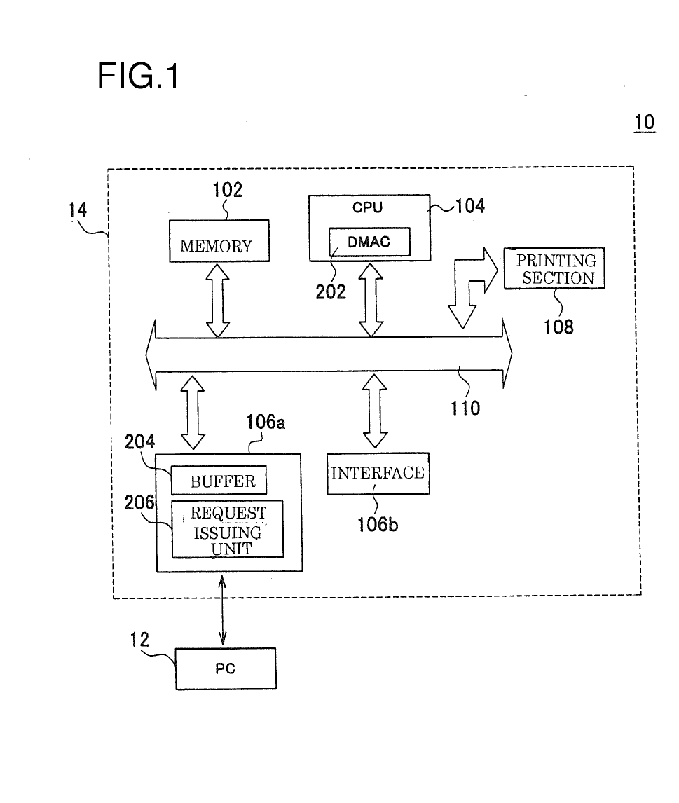

Hereinafter, an embodiment of the present invention will be described with reference to the attached drawings. FIG. 1 shows a structural example of a printing system 10 according to the embodiment of the present invention. The printing system 10 is an example of a system for transferring data by means of Direct Memory Access (DMA) and comprises a personal computer (PC) 12 and a printer 14. The PC 12 is an example of a transfer target device as an aim of data transfer by DMA. In this embodiment, the PC 12 is a computer for controlling the printer 14 and, for example, supplies print data, to be printed by the printer 14, to the printer 14.

The printer 14 is an example of a data transfer device for data transfer by DMA. In this embodiment, the printer 14 is an inkjet printer which conducts printing based on the print data received from the PC 12. The printer 14 comprises a memory 102, a central processing unit (CPU) 104, a plurality of interfaces 106a, 106b, a printing section 108, and a bus 110.

The memory 102 is a main memory of the printer 14 for storing various data such as the print data received from the PC 12. The CPU 104 is a controller for controlling the entire operation of the printer 14. In this embodiment, the CPU 104 has a built-in direct memory access controller (DMAC) 202. The DMAC 202 is a direct memory access controller for controlling the data transfer in response to the request signals from external devices.

The plurality of interfaces 106a, 106b input or output data relative to the outside of the printer 14. The interface 106a is, for example, a universal serial bus (USB) interface and is connected to the PC 12. In this embodiment, the interface 106a has a buffer 204 and a request issuing unit 206. The buffer 204 is a buffer which temporarily stores data to be transferred from or to the PC 12. The request issuing unit 206 is a circuit which issues a request signal for requesting data transfer to the memory 102.

The interface 106b is an interface, for example, of which standard is different from that of the interface 106a. The interface 106b may be, for example, a card reader for inputting or outputting data relative to a memory card, or may be a parallel interface. The interface 106b has, for example, a buffer 204 and a request issuing unit 206, similarly to the interface 106a. The interface 106b may be a USB interface which is identical or similar to the interface 106a. Further, the interface 106b may be connected to a second PC 12. In this case, the printing system 10 comprises a plurality of PCs 12 as transfer target devices which are initiator modules of transfer. In the printer 14, the plurality of interfaces 106a, 106b corresponding to the plurality of PCs 12 have respective request issuing units 206 for issuing request signals for requesting data transfer to the corresponding PCs 12. Also in this case, the data transfer as will be described below can be suitably conducted.

The printing section 108 is a printing mechanical section for conducting printing according to print data stored in the memory 102, and comprises a print head such as an inkjet head and a driving section for moving a medium relative to the print head, for example. The printing section 108 may receive print data from the memory 102, for example, transferred by means of the DMA. In this case, the printing section 108 preferably has a request issuing unit which is, for example, identical or similar to the request issuing unit 206 in the interface 106a. The bus 110 is a bus for transferring the data within the printer 14 and composes, for example, at least a portion of the data transfer channels between the memory 102 and the interfaces 106a, 106b. Moreover, in this embodiment, the bus 110 and the respective interfaces 106a, 160b are connected to each other by data transfer channels provided with signal wires for request signals. According to this embodiment, suitable printing can be conducted based on the print data supplied from the PC 12 to the printer 14.

In this embodiment, no signal wire for acknowledgement signals is provided in the data transfer channels between the interfaces 106a, 106b and the memory 102. Accordingly, the request issuing unit 206 issues a request signal without receiving an acknowledgement signal from the DMAC 202. As for terminals for control signals, the request issuing unit 206 has, for example, a terminal for request signals and no terminal for acknowledgement signals.

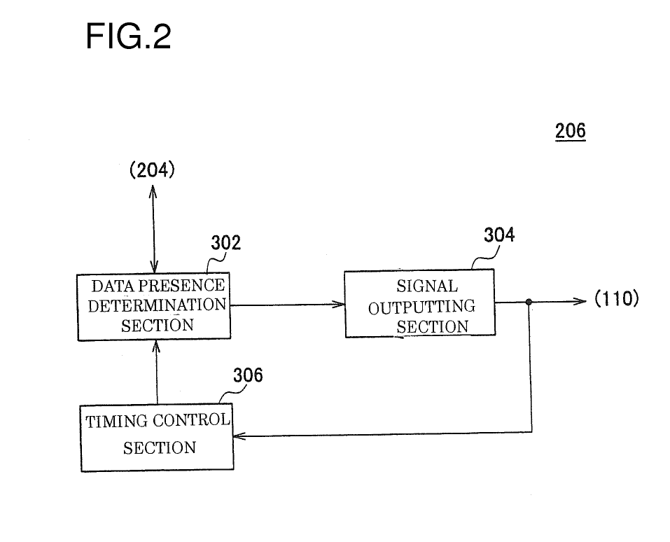

FIG. 2 shows a structural example of the request issuing unit 206. In this embodiment, the request issuing unit 206 comprises a data presence determination section 302, a signal outputting section 304, and a timing control section 306.

The data presence determination section 302 checks the state of the buffer 204 to determine whether or not transfer data as object of the data transfer by direct memory access are present, for example. The data presence determination section 302 notifies the signal outputting section 304 of a result of the determination. The data presence determination section 302 may determine the presence of the transfer data based on the information from the PC 12 as the transfer target device.

Based on the notification of the data presence determination section 302, the signal outputting section 304 outputs a request signal for requesting data transfer by DMA. In this embodiment, when the data presence determination section 302 determines that the transfer data are present, the signal outputting section 304 outputs a request signal for requesting data transfer of a predetermined amount of data to be transferred at one time.

The timing control section 306 controls timing of the determination of the data presence determination section 302 about presence of transfer data. In this embodiment, the timing control section 306 waits for a predetermined waiting period of time after the signal outputting section 304 outputs the request signal. The waiting period of time is set to at least an amount of time required for completing the data transfer by DMA of the amount of the data to be transferred at one time. After waiting, the timing control section 306 makes the data presence determination section 302 to determine whether or not transfer data are present.

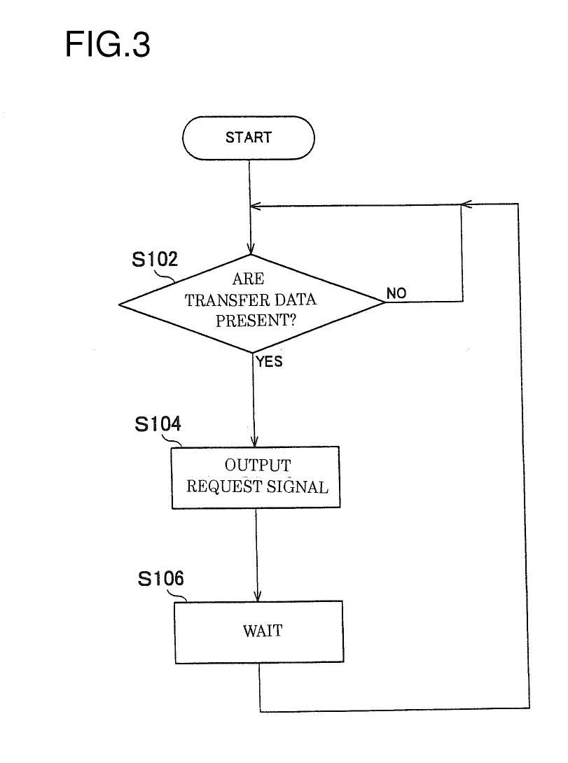

FIG. 3 is a flow chart showing an example of operation of the request issuing unit 206. In the request issuing unit 206 of this embodiment, for example, the data presence determination section 302 first determines whether or not transfer data as object of data transfer are present (data presence determination step S102). When it is determined that the transfer data are not present (No at S102), the data presence determination step S102 is repeated after a lapse of a certain period of time, for example.

When the data presence determination section 302 determines that the transfer data are present (Yes at S102), the signal outputting section 304 outputs a request signal (signal outputting step S104). After the request signal is outputted, the timing control section 306 controls timing to wait for an amount of time required for completing data transfer by DMA of at least the amount of data to be transferred at one time (waiting step S106). After waiting, the process is returned to the data presence determination step S102 and the following steps are repeated.

According to the aforementioned actions, after outputting every request signal, the request issuing unit 206 waits while the data transfer corresponding to the request signal is performed. After waiting, the request issuing unit 206 determines again whether or not transfer data are present. When the transfer data are present, the request issuing unit 206 outputs a request signal again. In response to the request signal outputted by the signal outputting section 304, the DMAC 202 controls data transfer by DMA of a predetermined amount of data to be transferred at one time.

By the aforementioned actions, this embodiment can prevent overlapping receipt of request signals without using an acknowledgement signal, for example. Further, by suitably coupling the output of a request signal and data transfer, the output of the request signal and the data transfer corresponding to the request signal can be suitably managed.

Accordingly, data transfer by direct memory access can be suitably performed without using an acknowledgement signal, for example. Since an acknowledgement signal is no more required, it is possible to reduce the number of control signals required to control data transfer by DMA to half. This can also suitably reduce the system cost of the system for performing data transfer by DMA. Furthermore, since the number of signal wires required for controlling data transfer is reduced, the data transfer channels can be suitably provided even when only a small space is allowed for wiring.

The DMAC 202 (see FIG. 1) for receiving request signals may receive multi-bit request signals so that the DMAC 202 is able to receive various types of request signals. In this case, the DMAC 202 can control various types of data transfers of which amounts to be transferred at one time are different, according to received request signal. Further in this case, the signal outputting section 304 preferably issues a request signal for requesting data transfer of which amount to be transferred at one time is minimal, among the various types of data transfers. According to this arrangement, by using the request signal for data transfer requiring minimal time, the waiting period of time in which the request issuing unit 206 waits the completion of the transfer is reduced, thereby further ensuring data transfer by DMA.

Though the present invention has been described with regard to the embodiment, the technical scope of the present invention is not limited to the scope described in the aforementioned embodiment. It will be apparent to those skilled in the art that various modifications and improvements can be applied to the aforementioned embodiment. It is apparent from the claims of the present invention that embodiments with such modifications and improvements are within the technical scope of the present invention.

The present invention can be suitably used in a data transfer device, for example.

Embodiments of the invention can suitably reduce system cost of a system for performing data transfer by DMA.

For example, the embodiment shown in FIG. 1 depicts a data transfer device that includes a memory, a request issuing unit 206 for issuing a request signal, and a DMAC 202. The request issuing unit 206 includes a data presence determination section which determines whether or not transfer data are present, a signal outputting section for outputting a request signal when the data presence determination section determines that the transfer data are present, and a determination timing control section which waits for a predetermined waiting period of time, required for completing the data transfer of at least an amount of data to be transferred at one time, after the signal outputting section outputs the request signal, and then makes the data presence determination section to determine again whether or not transfer data are present. When the signal outputting section outputs the request signal, the DMAC 202 controls data transfer by DMA of the amount of data to be transferred at one time in response to the request signal.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed is:

1. A data transfer device for performing data transfer by direct memory access, said data transfer device comprising:
a memory;
a request issuing unit configured to issue a request signal for requesting the data transfer to said memory; and
a direct memory access controller configured to control the data transfer,
wherein said request issuing unit comprises:
a data presence determination section configured to determine whether or not transfer data, as an object of the data transfer, is present;
a signal outputting section configured to output a request signal for data transfer of a predetermined amount of data to be transferred at one time when said data presence determination section determines that the transfer data is present; and
a determination timing control section configured to wait for a predetermined waiting period of time, required for completing data transfer of at least the predetermined amount of data to be transferred at one time, after said signal outputting section outputs the request signal, and then makes said data presence determination section to determine again whether or not transfer data is present, and
wherein, when said signal outputting section outputs the request signal, said direct memory access controller controls the data transfer by direct memory access of the amount of data to be transferred at one time in response to the request signal.

2. A data transfer device as claimed in claim 1, wherein:
said direct memory access controller is able to control various types of data transfers of which amounts to be transferred at one time are different, and
said request issuing unit is configured to issue the request signal for requesting data transfer of which amount to be transferred at one time is minimal, among the various types of data transfers.

3. A data transfer device as claimed in claim 1, wherein said request issuing unit issues the request signal without having received an acknowledgement signal from the direct memory access controller.

4. A data transfer device as claimed in claim 2, wherein said request issuing unit issues the request signal without having received an acknowledgement signal from the direct memory access controller.

5. A request issuing unit for issuing a request signal for requesting data transfer by direct memory access, said request issuing unit comprising:
a data presence determination section configured to determine whether or not transfer data, as an object of the data transfer, is present;
a signal outputting section configured to output a request signal for data transfer of a predetermined amount of data to be transferred at one time when said data presence determination section determines that the transfer data is present; and
a determination timing control section configured to wait for a predetermined waiting period of time, required for completing the data transfer of at least the amount of data to be transferred at one time, after said signal outputting section outputs the request signal, and then makes said data presence determination section determine again whether or not transfer data is present.

6. A request issuing unit as claimed in claim 5, wherein said request issuing unit issues the request signal without having received an acknowledgement signal from a direct memory access controller.

7. A request issuing method for issuing a request signal for requesting data transfer by direct memory access, said request issuing method comprising:
determining whether or not transfer data, as an object of the data transfer, is present;
outputting a request signal for data transfer of a predetermined amount of data to be transferred at one time when it is determined that the transfer data is present; and
waiting for a predetermined waiting period of time, required for completing the data transfer of at least the amount of data to be transferred at one time, after the request signal is outputted,
wherein, after waiting for the predetermined waiting period of time, the method is returned to determining again whether or not transfer data is present.

8. A request issuing method as claimed in claim 7, wherein the request signal is output without having received an acknowledgement signal from a direct memory access controller.
